(19) United States
(12) Patent Application Publication
(10) Pub. No.: US 2021/0366635 A1
(43) Pub. Date: Nov. 25, 2021

(54) RARE EARTH SINTERED MAGNET AND MAKING METHOD

(71) Applicant: Shin-Etsu Chemical Co., Ltd., Tokyo (JP)

(72) Inventors: Yosuke SHINADA, Echizen-shi (JP); Tetsuya KUME, Echizen-shi (JP); Koichi HIROTA, Echizen-shi (JP)

(73) Assignee: Shin-Etsu Chemical Co., Ltd., Tokyo (JP)

(21) Appl. No.: 17/240,451

(22) Filed: Apr. 26, 2021

(30) Foreign Application Priority Data
May 19, 2020 (JP) 2020-087344

(51) Int. Cl. H01F 1/053; H01F 41/02; H01F 1/057

(52) U.S. Cl. CPC H01F 1/0536; H01F 1/0573; H01F 41/0253

(57) ABSTRACT

A rare earth sintered magnet is prepared by a method comprising the steps of melting raw materials to form an alloy, pulverizing the alloy into a fine powder, shaping the fine powder into a compact, and sintering the compact. The pulverizing step includes a coarse pulverizing step including hydrogen decrepitation and a fine pulverizing step, and further includes the step of adding a lubricant. The sintering step includes an atmosphere heat treatment including heating the compact at a temperature from the lubricant decomposition temperature to the sintering temperature and holding at the temperature for a time, in an inert gas atmosphere, and a vacuum heat treatment. The sintered magnet has a low impurity concentration and a narrow carbon concentration distribution.

### CROSS-REFERENCE TO RELATED APPLICATION

This non-provisional application claims priority under 35 U.S.C. § 119(a) on Patent Application No. 2020-087344 filed in Japan on May 19, 2020, the entire contents of which are hereby incorporated by reference.

### TECHNICAL FIELD

This invention relates to a rare earth sintered magnet having a low impurity concentration and a narrow carbon concentration distribution within it and a method for preparing the same.

### BACKGROUND ART

Rare earth sintered magnets are a class of functional material which is essential for energy saving and greater functionality, and their application range and production quantity are annually expanding. Among rare earth sintered magnets, Nd-based sintered magnets, referred to as Nd magnets, hereinafter, have a high remanence (designated Br, hereinafter). They are used, for example, in drive motors in hybrid cars and electric vehicles, motors in electric power steering systems, motors in air conditioner compressors, and voice coil motors (VCM) in hard disk drives. While Nd magnets having high Br are used in motors for various applications, Nd magnets having higher values of Br are desired for manufacturing motors of smaller size.

On the other hand, rare earth sintered magnets reduce their coercivity (designated Hcj, hereinafter) at high temperature, with irreversible thermal demagnetization taking place. Especially, the rare earth sintered magnets intended for use in motors mounted on electric and other vehicles are required to have higher values of Hcj.

In the prior art, one typical means for enhancing the Hcj of Nd magnets is to add heavy rare earth elements such as Dy and Tb. This means, however, is not necessarily preferable for the reason that the heavy rare earth elements are rare resources and expensive.

Another known means for enhancing the Hcj of Nd magnets is size reduction of crystal grains. In a process involving finely pulverizing a material, shaping and sintering, this means intends to reduce the particle size during fine pulverization, thereby obtaining crystal grains of small size at the end of sintering. It is known that in a certain range of particle size, Hcj increases in linear proportion to a size reduction. When the material is finely pulverized below a certain level, the concentration of impurities (mainly oxygen and nitrogen) in the finely pulverized material becomes high as a result of a lowering of the fine pulverizing capability and an increase of reactivity of finely pulverized material. There arises the problem that the Hcj of Nd magnet lowers or that even when an increase of Hcj is observed, it is difficult to increase Hcj by the grain boundary diffusion method (to be described later). For achieving improvements in these respects, Patent Document 1 discloses to change the jet gas during fine pulverization to a rare gas such as He or Ar, and Patent Documents 2 and 3 describe to use hydrogen-containing powder during fine pulverization.

A further means for enhancing the Hcj of Nd magnets is known from Patent Documents 4 and 5 which describe the grain boundary diffusion method of selectively concentrating heavy rare earth elements (e.g., Dy and Tb) in the grain boundary phase in Nd magnets. In this method, a compound of a heavy rare earth element such as Dy or Tb is deposited on the magnet surface as by coating, and then heat treatment is carried out at high temperature. There is formed a Nd magnet of structure that the concentration of Dy or Tb is high only in a region close to the grain boundaries of major phase grains, thereby achieving a Hcj enhancement effect while restraining a drop of Br.

### CITATION LIST

Patent Document 1: WO 2014/142137 (US 2016027564)

Patent Document 2: WO 2013/100008 (U.S. Pat. No. 9,028,624)

Patent Document 3: WO 2014/123079

Patent Document 4: WO 2006/044348

Patent Document 5: WO 2013/100010

### SUMMARY OF INVENTION

The means of changing the jet gas during fine pulverization to a rare gas such as He or Ar, as disclosed in Patent Document 1, is awkward at industrial magnet manufacture because of a noticeable price difference from nitrogen gas. The grain boundary diffusion method described in Patent Documents 4 and 5 is quite effective for acquiring a high coercivity, but has the problem that the Hcj enhancement effect is substantially reduced when the amount of additive elements or R in Nd magnet is reduced for improving the Br of Nd magnet or when the amount of impurity elements (e.g., carbon, oxygen and nitrogen) is increased by adding a more amount of lubricant to facilitate orientation. Since a certain limit is imposed on the extent of the Hcj enhancement effect by the grain boundary diffusion method, it is necessary in the electric vehicle and other applications in need for high heat resistance to increase the Hcj of magnet matrix itself prior to the grain boundary diffusion method.

The method of Patent Documents 2 and 3 intends to inhibit oxidation by fine pulverization of hydrogen-containing powder in an oxygen-free atmosphere and to reduce the carbon concentration by decomposition of the additive lubricant with liberated hydrogen during sintering. This method is effective for reducing the impurity concentration, especially carbon concentration in the magnet. However, the organic lubricant evaporates during sintering to give off hydrocarbon gases in the heat treatment furnace. Under the influence of the gas attack, the carbon concentration from the magnet surface to a depth of at most several millimeters becomes higher than in the magnet interior. Since carbon is generally an impurity element that adversely affects magnetic properties, especially coercivity, a surface portion of the magnet produced by the method must be largely ground off, yielding a detrimental impact on the industrial productivity.

An object of the invention is to provide a rare earth sintered magnet having a low impurity concentration and a small difference in carbon concentration within it and a method for preparing the same.

Focusing on sintering heat treatment conditions, the inventors have found that in the method of using a hydrogen-containing powder during fine pulverization, prior to vacuum sintering treatment at a sintering temperature, the compact is held in an inert gas atmosphere of a proper pressure range at a proper temperature range below the sintering temperature for a predetermined time, whereby the difference in carbon concentration between a surface portion and a center portion of the magnet is minimized. For example, there is obtained a sintered magnet wherein the difference in carbon concentration between a surface portion and a center portion is 0.005 to 0.03% by weight. By preventing the carbon concentration of the magnet surface portion from increasing during sintering, a high performance magnet is efficiently produced.

Accordingly, the invention provides a rare earth sintered magnet and a method for preparing the same, as defined below.

In one aspect, the invention provides a method for preparing a rare earth sintered magnet, the sintered magnet consisting essentially of R, T, B, M¹, and M² wherein R is at least one element selected from rare earth elements, essentially including neodymium, T is at least one element selected from iron group elements, essentially including iron, B is boron, M¹ is at least one element selected from the group consisting of Al, Si, Cr, Mn, Cu, Zn, Ga, Ge, Mo, Sn, W, Pb, and Bi, and M² is at least one element selected from the group consisting of Ti, V, Zr, Nb, Hf, and Ta,
the method comprising the steps of melting raw materials to form a starting alloy having a predetermined composition, pulverizing the starting alloy into an alloy fine powder, compression shaping the alloy fine powder under a magnetic field into a compact, and sintering the compact by heat treatment at a sintering temperature into a sintered magnet, wherein
the pulverizing step includes coarse pulverizing and fine pulverizing steps, the coarse pulverizing step including a hydrogen decrepitation step, the pulverizing step further includes the step of adding a lubricant before or after the coarse pulverizing step,
the sintering step includes an atmosphere heat treatment and a vacuum heat treatment,
the atmosphere heat treatment including the steps of heating the compact at a predetermined temperature ranging from the decomposition temperature of the lubricant to the sintering temperature, and holding at the predetermined temperature for a predetermined time, the heating and holding steps being carried out in an inert gas atmosphere under a pressure of 10 to 100 kPa, and
the vacuum heat treatment including the steps of switching the atmosphere to a vacuum atmosphere after the atmosphere heat treatment and heating the compact in the vacuum atmosphere at the sintering temperature.

In one preferred embodiment, the lubricant is at least one compound selected from the group consisting of stearic acid, zinc stearate, decanoic acid, and lauric acid.

In one preferred embodiment, the inert gas of the inert gas atmosphere used in the atmosphere heat treatment is He gas, Ar gas or N₂ gas.

In one preferred embodiment, the predetermined temperature ranging from the decomposition temperature of the lubricant to the sintering temperature is in the range of 400° C. to 800° C.

In one preferred embodiment, the holding time at the predetermined temperature during the atmosphere heat treatment is 0.5 to 10 hours.

In one preferred embodiment, the hydrogen decrepitation step is under a hydrogen pressure of at least 100 kPa,
the fine pulverizing step includes finely pulverizing the coarsely pulverized starting alloy in a non-oxidizing gas atmosphere having a water content of up to 100 ppm to a volume basis median diameter D₅₀ of 0.2 to 10 μm.

In one preferred embodiment, during the atmosphere heat treatment, the steps of vacuum evacuating at a rate of 0.1 to 1,000 kPa/min and subsequently introducing the inert gas at a rate of 0.1 to 100 kPa/min are performed plural times while keeping the inert gas atmosphere pressure of 10 to 100 kPa.

In one preferred embodiment, during the atmosphere heat treatment, the inert gas atmosphere pressure which is in the range of 10 to 100 kPa is changed from more than 0.5 Pₖ to less than 1.5 Pₖ, provided that a predetermined pressure Pₖ is set within the range.

In another aspect, the invention provides a rare earth sintered magnet which is prepared by a technique of using a hydrogen-containing powder during fine pulverization of a starting alloy, wherein the difference ΔC between a carbon concentration Cₛ in a magnet surface portion and a carbon concentration C_{c} in a magnet center portion is 0.005 to 0.03% by weight.

Typically, the rare earth sintered magnet consists essentially of R, T, B, M¹, and M² wherein R is at least one element selected from rare earth elements, essentially including neodymium, T is at least one element selected from iron group elements, essentially including iron, B is boron, M¹ is at least one element selected from the group consisting of Al, Si, Cr, Mn, Cu, Zn, Ga, Ge, Mo, Sn, W, Pb, and Bi, and M² is at least one element selected from the group consisting of Ti, V, Zr, Nb, Hf, and Ta, the magnet having an oxygen content of up to 0.1% by weight, a nitrogen content of up to 0.05% by weight, and a carbon content of up to 0.07% by weight.

In one embodiment, the rare earth sintered magnet has a R content of 12.0 to 16.0 atom %, a M¹ content of 0.1 to 2.0 atom %, and a M² content of 0.1 to 0.5 atom % wherein R is at least one element selected from rare earth elements, essentially including neodymium, M¹ is at least one element selected from the group consisting of Al, Si, Cr, Mn, Cu, Zn, Ga, Ge, Mo, Sn, W, Pb, and Bi, and M² is at least one element selected from the group consisting of Ti, V, Zr, Nb, Hf, and Ta.

In one embodiment, the rare earth sintered magnet has an average crystal grain size of up to 4 μm.

In one embodiment, the rare earth sintered magnet has a degree of orientation Oᵣ (%) and an average crystal grain size D (μm), which meet the relationship (1):

0.26×D+97≤Oᵣ≤0.26×D+99 (1).

In a preferred embodiment, with respect to major phase grains at least in an area delineated within 500 μm from the surface of the sintered magnet, each major phase grain contains in at least a portion near the major phase grain surface, a region having a higher concentration of R′ than at the major phase grain center, wherein R′ is at least one element selected from rare earth elements and constitutes at least a part of R.

### ADVANTAGEOUS EFFECT OF INVENTION

According to the invention, a rare earth sintered magnet having a low impurity concentration and a narrow carbon concentration distribution can be prepared. The rare earth sintered magnet exhibits excellent magnetic properties.

### DESCRIPTION OF PREFERRED EMBODIMENTS

The method for preparing a rare earth sintered magnet according to the invention involves the steps of melting raw materials to form a starting alloy having a predetermined composition, pulverizing the starting alloy into an alloy fine powder, compression shaping the alloy fine powder under a magnetic field into a compact, and sintering the compact by heat treatment at a sintering temperature into a sintered magnet.

First, in the melting step, metals or alloys as raw materials for necessary elements are weighed so as to meet the predetermined composition. After weighing, the raw materials are melted, for example, by high-frequency induction heating. The melt is cooled to form a starting alloy having the predetermined composition. For casting of the starting alloy, the melt casting technique of casting in a flat mold or book mold or the strip casting technique is generally employed. Also applicable herein is a so-called two-alloy technique involving separately furnishing an alloy approximate to the R2Fe14B compound composition that constitutes the major phase and an R-rich alloy serving as liquid phase aid at the sintering temperature, crushing, then weighing and mixing them. Since the alloy approximate to the major phase composition tends to allow α-Fe phase to crystallize depending on the cooling rate during casting and the alloy composition, the alloy is preferably subjected to homogenizing treatment in vacuum or Ar atmosphere at 700 to 1,200° C. for at least 1 hour, if desired, for the purpose of homogenizing the structure to eliminate the α-Fe phase. When the alloy approximate to the major phase composition is prepared by the strip casting technique, the homogenizing treatment may be omitted. To the R-rich alloy serving as liquid phase aid, not only the casting technique mentioned above, but also the so-called melt quenching technique are applicable.

The rare earth sintered magnet prepared herein consists essentially of R, T, B, M¹, and M² wherein R is at least one element selected from rare earth elements, essentially including neodymium (Nd), T is at least one element selected from iron group elements, essentially including iron (Fe), B is boron, M¹ is at least one element selected from the group consisting of Al, Si, Cr, Mn, Cu, Zn, Ga, Ge, Mo, Sn, W, Pb, and Bi, and M² is at least one element selected from the group consisting of Ti, V, Zr, Nb, Hf, and Ta. The metals or alloys used as raw materials are selected in accordance with the desired composition of the magnet. The composition of the magnet prepared herein will be defined later.

The pulverizing step is a multi-stage step including at least coarse pulverizing and fine pulverizing steps. In the coarse pulverizing step, any suitable technique such as grinding on a jaw crusher, Brown mill or pin mill, or hydrogen decrepitation may be used. In the practice of the invention, a hydrogen decrepitation step is included as at least one step of the coarse pulverizing step, for the purpose of reducing O, N and C contents to acquire improved magnetic properties. The hydrogen decrepitation step is a hydrogen occlusion/pulverization step of exposing an alloy mass to a hydrogen atmosphere of a certain pressure or above for causing the alloy to occlude hydrogen. Although the hydrogen pressure used herein is not particularly limited, a hydrogen pressure of at least 100 kPa is preferred because a wastefully long time taken for hydrogen occlusion can adversely affect productivity. After the hydrogen decrepitation step, the alloy mass at elevated temperature is cooled and conveyed to the subsequent step. At this point of time, the alloy is preferably cooled near room temperature from the aspect of anti-oxidation. The hydrogen decrepitation step generally yields a coarse powder which has been coarsely pulverized to a size of 0.05 to 3 mm, especially 0.05 to 1.5 mm.

The coarse pulverizing step is followed by the fine pulverizing step where the coarse powder may be pulverized on a jet mill using a non-oxidative gas stream such as N₂, He or Ar. In the fine pulverizing step, the coarse powder is preferably pulverized to a volume basis median diameter D₅₀ of 0.2 to 10 μm, more preferably 0.5 to 5 μm. Since impurities O and N in the rare earth sintered magnet are mainly introduced in the fine pulverizing step, the jet mill atmosphere must be controlled in order to adjust the O and N contents in the magnet. For example, the O content in the rare earth sintered magnet is adjusted by controlling the O content and the dew point of the jet mill atmosphere. Preferably the jet mill atmosphere is controlled to a water content of up to 100 ppm and an oxygen concentration of up to 1 ppm. It is noted that the volume basis median diameter D₅₀ is a particle size corresponding to 50% accumulation of volume frequency.

The N content in the rare earth sintered magnet may be adjusted by (A) a technique of finely pulverizing on a jet mill with He or Ar gas jet, (B) a technique of finely pulverizing on a jet mill with N₂ gas jet while introducing hydrogen, or (C) a technique of finely pulverizing hydrogen-containing coarse powder on a jet mill with N₂ gas jet. Then hydrogen preferentially adsorbs to the active surface created by grinding action to prevent adsorption of nitrogen, for thereby reducing the N content in the rare earth sintered magnet.

Before or after the coarse pulverizing step, the pulverizing step includes the step of adding a lubricant for enhancing the orientation or alignment of particles during the subsequent step of shaping the powder in a magnetic field. Examples of the lubricant include saturated fatty acids such as stearic acid (Td 376° C.), decanoic acid (Td 270° C.), lauric acid (Td 225° C.), and saturated fatty acid salts such as zinc stearate (Td 376° C.). It is noted that Td designates a decomposition temperature. In the lubricant adding step, increasing the amount of the lubricant added is generally effective for promoting orientation, but raises the problem that carbon originating from the lubricant forms more R-CON phase in the rare earth sintered magnet to bring about a considerable drop of Hcj. Since the fine powder resulting from fine pulverization of hydrogen-containing coarse powder is used herein, the amount of the lubricant added to the fine powder can be increased for promoting orientation. In the method of preparing the rare earth sintered magnet from such fine powder, since internal hydrogen is released during heat treatment, the hydrogen acts to decompose the lubricant chemically adsorbing to fine particle surfaces through carbonyl reductive reaction or the like, and hydrogen gas-induced cracking reaction forces further decomposition and dissociation to highly volatile lower alcohols. Consequently, the C content remaining in the rare earth sintered magnet is reduced. The amount of the lubricant added is suitably determined depending on the type of lubricant or the like, and not particularly limited. The amount of the lubricant added is preferably 0.01 to 0.5 part by weight, more preferably 0.05 to 0.3 part by weight per 100 parts by weight of the coarse powder or starting alloy.

In the shaping step, the alloy powder is compression shaped into a compact by a compression shaping machine while applying a magnetic field of 400 to 1,600 kA/m for orienting or aligning powder particles in the direction of axis of easy magnetization. The compact preferably has a density of 2.8 to 4.2 g/cm³. It is preferred from the aspect of establishing a compact strength for easy handling that the compact have a density of at least 2.8 g/cm³. For further increasing the strength of the compact as shaped, a binder such as PVA or fatty acid may be added to the powder. It is also preferred from the aspects of establishing a sufficient compact strength and preventing any disordering of particle orientation during compression to gain appropriate Br by that the compact have a density of up to 4.2 g/cm³. The shaping step is preferably performed in an inert gas atmosphere such as nitrogen gas or Ar gas to prevent the alloy powder from oxidation.

The sintering step is to sinter the compact from the shaping step in an inert gas atmosphere such as Ar gas or in high vacuum. According to the invention, the sintering step includes an atmosphere heat treatment (i.e., heat treatment in an inert gas atmosphere) and a vacuum heat treatment (i.e., heat treatment in a vacuum atmosphere). In the inventive method using hydrogen-containing coarse powder, the compact is held at a predetermined temperature for a predetermined time in an inert gas atmosphere during the atmosphere heat treatment step to prevent the occurrence of cracks due to a temperature drop and temperature difference in the compact associated with the release (endothermic reaction) of hydrogen gas in the compact, before the compact is sintered in the vacuum heat treatment step. For sufficient decomposition of the lubricant with hydrogen gas, the holding temperature during the atmosphere heat treatment step should range from the decomposition temperature of the lubricant to the sintering temperature. The holding temperature may be set appropriate depending on the type of lubricant. The holding temperature is preferably from 400° C. to 800° C., for example, when stearic acid (Td 376° C.), decanoic acid (Td 270° C.), lauric acid (Td 225° C.) or zinc stearate (Td 376° C.) is used as the lubricant. Similarly, the holding time is preferably 0.5 to 10 hours, for example. To restrain the carbon concentration distribution in the magnet by gas attack from hydrocarbon gas resulting from decomposition of the lubricant, the step of holding at a predetermined temperature for a predetermined time during the atmosphere heat treatment step is carried out in an inert gas atmosphere under a pressure of 10 to 100 kPa. As long as these holding conditions are met, the influence of gas attack near the magnet surface is mitigated while promoting the decomposition of the lubricant in the magnet.

In the atmosphere heat treatment step, the steps of vacuum evacuating at a rate of 0.1 to 1,000 kPa/min and introducing an inert gas at a rate of 0.1 to 100 kPa/min may be performed plural times while the inert gas atmosphere is maintained in the above-mentioned pressure range of 10 to 100 kPa. This is effective for reducing the hydrocarbon gas concentration in the system for effectively mitigating the influence of gas attack on the magnet. In a more preferred embodiment, the vacuum evacuation and inert gas introduction are repeated such that the inert gas atmosphere pressure, which is in the above-mentioned pressure range of 10 to 100 kPa, is changed from more than 0.5 Pₖ to less than 1.5 Pₖ, provided that a predetermined pressure Pₖ is set within the range. As long as these holding conditions are met, the influence of gas attack near the magnet surface is effectively and positively mitigated while promoting the decomposition of the lubricant in the magnet.

In the atmosphere heat treatment step, the inert gas of the inert gas atmosphere is preferably selected from He, Ar and N₂ gases though not particularly limited.

Next comes the vacuum heat treatment step, which is to heat treat the compact in high vacuum at the sintering temperature. The preferred heat treatment is by holding the compact at a temperature of 950 to 1,200° C. for a time of 0.5 to 10 hours.

In the practice of the invention, after the atmosphere heat treatment step and vacuum heat treatment step are successively performed in the sintering step, the thus sintered body may be further heat treated at a temperature lower than the sintering temperature for the purpose of enhancing Hcj. This heat treatment after the sintering step may be heat treatment in two stages including high-temperature heat treatment and low-temperature heat treatment, or only low-temperature heat treatment. The high-temperature heat treatment is preferably to heat treat the sintered body at 600 to 950° C. The low-temperature heat treatment is preferably to heat treat the sintered body at 400 to 600° C.

In a further embodiment, the rare earth sintered magnet thus obtained is ground to a desired shape, covered with a diffusion source, and further heat treated in the state that the diffusion source is present on the magnet surface. This treatment is known as grain boundary diffusion treatment. The diffusion source is one or more members selected from oxides of R¹, fluorides of R², oxyfluorides of R³, hydroxides of R⁴, carbonates of R⁵, basic carbonates of R⁶, single metal or alloys of R⁷ wherein each of R¹ to R⁷ is at least one element selected from rare earth elements. The means of securing the diffusion source to the magnet surface may be a dip coating technique of dipping the sintered magnet in a slurry of the powdered diffusion source to coat the magnet with the slurry and drying, a screen printing technique, or a dry coating technique such as sputtering or pulsed laser deposition (PLD). The temperature of grain boundary diffusion treatment is lower than the sintering temperature and preferably at least 700° C. From the aspect of obtaining the sintered magnet having improved structure and magnetic properties, the treatment time is preferably 5 minutes to 80 hours, more preferably 10 minutes to 50 hours, though not particularly limited. The grain boundary diffusion treatment causes R¹ to R⁷ to diffuse from the coating to the magnet for thereby achieving a further increase of Hcj. Although the rare earth element to be introduced by the grain boundary diffusion treatment is designated R¹ to R⁷ for the sake of description, any of R¹ to R⁷ is included in the R component in the rare earth sintered magnet at the end of grain boundary diffusion treatment. The diffusion source containing R¹ to R⁷ is preferably a metal, compound or intermetallic compound containing HR which is at least one element selected from Dy, Tb and Ho because these are more effective for increasing Hcj.

The magnet having subjected to grain boundary diffusion treatment shows a characteristic concentration distribution of R element. With respect to major phase grains in an area delineated within at least 500 μm from the surface of the sintered magnet (on which the diffusion source has been deposited), each major phase grain contains in at least a portion near the major phase grain surface, a region having a higher concentration of R′ than at the major phase grain center, wherein R′ is at least one element selected from rare earth elements and generically designates the R¹ to R⁷ element introduced by the grain boundary diffusion treatment.

The rare earth sintered magnet which is prepared by the inventive method is characterized by a narrow carbon concentration distribution. In one preferred embodiment of the rare earth sintered magnet, the difference ΔC between a carbon concentration Cₛ in a surface portion and a carbon concentration C_{c} in a center portion of the sintered magnet is 0.005 to 0.03% by weight. This magnet meets both high Br and high Hcj. The reason is presumed as follows. In general, rare earth sintered magnets have the tendency that part of the rare earth element evaporates from a surface portion thereof during sintering. Then, the rare earth element becomes short in the magnet surface portion and in turn, the composition of the surface portion becomes Fe rich, forming R₂Fe₁₇ phase and thus inviting drops of Br and Hcj. The formation of R₂Fe₁₇ phase in the surface portion can be restrained by increasing the amount of boron (B) added. In this event, however, the center portion turns B rich whereby R₁Fe₄B₄ phase precipitates with a drop of Br. It is generally known that carbon (C) forms R₂Fe₁₄X phase as major phase together with B wherein X is B or C. Therefore, when Cs is higher than Cc by at least 0.005% by weight, a sufficient amount of R₂Fe₁₄X phase can be formed in the magnet surface portion while restraining precipitation of R₁Fe₄B₄ phase in the magnet center portion. As a result, high Br and high Hcj are achieved. If the carbon concentration difference ΔC exceeds 0.03% by weight, carbon forms R₂Fe₁₄X phase as major phase and R—C—O compounds in the surface portion, which causes the amount of rare earth in the grain boundary phase to be reduced, leading to a substantial drop of Hcj.

The rare earth sintered magnet prepared by the inventive method consists essentially of R, T, B, M¹, and M², with the balance of O, N, C and incidental impurities. Herein R is at least one element selected from rare earth elements, essentially including Nd, T is at least one element selected from iron group elements, essentially including Fe, B is boron, M¹ is at least one element selected from the group consisting of Al, Si, Cr, Mn, Cu, Zn, Ga, Ge, Mo, Sn, W, Pb, and Bi, and M² is at least one element selected from the group consisting of Ti, V, Zr, Nb, Hf, and Ta.

R is at least one element selected from rare earth elements, essentially including Nd. The content of R is not particularly limited. From the aspect of preventing crystallization of α-Fe in the molten alloy or promoting normal consolidation during sintering, the content of R is preferably at least 12.0 atom %, more preferably at least 13.0 atom % of the overall rare earth magnet. From the aspect of obtaining high Br, the content of R is preferably up to 16.0 atom %, more preferably up to 15.5 atom %.

The proportion of Nd in R is preferably at least 60 atom %, more preferably at least 75 atom % of the total R elements, though not particularly limited. Suitable R elements other than Nd are Pr, Dy, Tb, Ho, Er, Sm, Ce, and Y, though not limited thereto.

T is at least one element selected from iron group elements, i.e., Fe, Co, and Ni, essentially including Fe. The content of T, which is the remainder other than R, B, M¹, M², O, C, and N, is preferably from 70 atom % to 85 atom % of the overall rare earth magnet. The content of Fe is preferably from 70 atom % to 82 atom %, more preferably from 75 atom % to 80 atom % of the overall rare earth magnet.

The content of B is preferably at least 5.0 atom %, more preferably at least 5.5 atom %, from the aspect of the major phase forming to a full extent to acquire high Br. The content of B is preferably up to 8.0 atom %, more preferably up to 7.0 atom % because an excessive content of B can cause precipitation of Nd₁Fe₄B₄ phase which is detrimental to Br.

M¹ is at least one element selected from the group consisting of Al, Si, Cr, Mn, Cu, Zn, Ga, Ge, Mo, Sn, W, Pb, and Bi. From the aspects of ensuring an optimum temperature width during heat treatment for acceptable productivity and suppressing a drop of Hcj, the content of M¹ is preferably at least 0.1 atom %, more preferably at least 0.3 atom %, even more preferably at least 0.5 atom %. From the aspect of obtaining high Br, the content of M¹ is preferably up to 2.0 atom %, more preferably up to 1.5 atom %.

M² is at least one element selected from the group consisting of Ti, V, Zr, Nb, Hf, and Ta. The inclusion of M² is effective for preventing crystal grains from abnormal growth during the sintering step to avoid a drop of Br. The content of M² is preferably up to 0.5 atom %, more preferably up to 0.3 atom %, even more preferably up to 0.2 atom %, though not critical. If the content of M² exceeds 0.5 atom %, M² element may form a M²-B phase to reduce the proportion of R₂T₁₄B phase, inviting a drop of Br. From the aspect of preventing crystal grains from abnormal growth, the content of M² is preferably at least 0.1 atom %.

The content of O is preferably up to 0.1% by weight, more preferably up to 0.08% by weight. An O content in the range is effective for suppressing any drops of magnetic properties, especially Hcj. Also, the content of N is preferably up to 0.05% by weight, more preferably up to 0.03% by weight. An N content in the range is effective for suppressing a drop of Hcj. Further, the content of C is preferably up to 0.07% by weight, more preferably up to 0.05% by weight. A C content in the range is effective for suppressing a drop of Hcj.

The rare earth sintered magnet of the invention preferably has an average crystal grain size of up to 4 μm, more preferably up to 3.5 μm. As long as the average crystal grain size is in the range, high values of Hcj are available. The average crystal grain size is measured by the following procedure, for example. A cross section of a sintered magnet is polished to mirror finish. The magnet is immersed in an etchant, for example, Vilella reagent (mixture of glycerol, nitric acid and hydrochloric acid in a ratio of 3:1:2) to selectively etch the grain boundary phase. The etched cross section is observed under a laser microscope. An image analysis is made on the image observed, and the cross-sectional area of individual grains is measured, from which the diameter of equivalent circle is computed. An average grain size is computed based on the data of the area fraction of a grain size. The average grain size may be, for example, an average of total approximately 2,000 grains in images of different 20 spots. The measurement can be readily performed by observing the magnet surface or cross section under a laser microscope, for example.

Preferably, the rare earth sintered magnet has a degree of orientation Oᵣ (%) and an average crystal grain size D (μm) as defined above, which meet the relationship (1).

0.26×D+97≤Oᵣ≤0.26×D+99 (1).

When the degree of orientation Oᵣ (%) and the average crystal grain size D (μm) meet the relationship (1), high values of Br and Hcj are available. Though not well understood, the reason is presumed as follows. In general, the reduction of crystal grain size is achieved by reducing the size of fine particles prior to shaping and sintering. As the fine powder particle size becomes smaller, the surface area of fine powder becomes larger. Then, the frictional resistance among fine particles increases to disturb orientation of fine particles during shaping in a magnetic field. In the inventors' experiment regarding a quantity of such change, for a fine powder corresponding to an average crystal grain size of up to 4 μm, a detrimental change of 0.26% is reported relative to a decrease of 1 μm in crystal grain size. It is known that a high value of Br is not achievable from a fine powder having a low degree of orientation whereas a sharp drop of Hcj occurs when the degree of orientation is too high. Examining these phenomena comprehensively, the inventors have discovered that high values of Br and Hcj are consistently available when the degree of orientation meets the relationship (1).

From the aspect of taking advantage of the potential of the material to acquire high values of Br, the degree of orientation Oᵣ is preferably at least 96%, more preferably at least 97%. Provided that a degree of orientation in the above range and an average crystal grain size of up to 4 μm are met, best results are obtained when the relationship (1) is met. It is noted that the degree of orientation Oᵣ (%) can be measured by any well-known techniques, typically electron back scatter diffraction patterns (EBSD).

### EXAMPLES

Examples of the invention are given below by way of illustration and not by way of limitation.

### Examples 1 to 16 and Comparative Examples 1 to 20

By furnishing Nd metal, Pr metal, ferroboron alloy, electrolytic Co, Al metal, Cu metal, Ga metal, Si metal, zirconium metal, and electrolytic iron (all metals are of purity ≥99%), weighing and mixing them in a predetermined ratio, melting them, and casting by the strip casting method, there was obtained a starting alloy in flake form having a thickness of 0.2 to 0.4 mm. The flake form starting alloy was pulverized by hydrogen decrepitation in a pressurized hydrogen atmosphere (hydrogen pressure 150 kPa, water content 2.2 ppm) into coarse pulverized powder. To 100 parts by weight of the coarse pulverized powder, 0.2 part by weight of stearic acid (Td 376° C.) as lubricant was added and mixed. Using a jet miller, the mix was subjected to dry pulverization in a nitrogen stream (water content 10 ppm), obtaining fine pulverized powder (alloy powder) having a pulverization particle size D₅₀ of 2.9 μm. It is noted that the pulverization particle size D₅₀ is a volume basis median diameter determined by the laser diffraction method based on gas stream dispersion. A mold of a shaping machine was filled with the fine pulverized powder in N₂ gas atmosphere. While being oriented under a magnetic field of 15 kOe (1.19 MA/m), the powder was compression shaped in a direction perpendicular to the magnetic field. The resulting compact had a density of 3.0 to 4.0 g/cm³.

The compact was subjected to atmosphere heat treatment in an Ar gas atmosphere under the conditions shown in Table 1, then to vacuum heat treatment in vacuum at a temperature of 1,040 to 1,080° C. (a temperature selected for each sample such that sufficient consolidation is achieved by sintering) for 5 hours, yielding a Nd magnet block. The Nd magnet block had a density of at least 7.5 g/cm³. The Nd magnet block at its center portion was subjected to metal component analysis by an inductively coupled plasma optical emission spectrometer (ICP-OES). All the magnets of Examples 1 to 16 and Comparative Examples 1 to 20 consisted of Nd 24.1 wt %, Pr 6.5 wt %, Fe 66.3 wt %, Co 0.5 wt %, Cu 0.2 wt %, Zr 0.2 wt %, Al 0.1 wt %, B 1 wt %, Si 0.1 wt %, Ga 0.8 wt %, and the balance of impurity elements. The block was further measured for a degree of orientation Oᵣ (%) by EBSD and for an average crystal grain size D (μm) under a laser microscope. All the magnets of Examples 1 to 16 and Comparative Examples 1 to 20 had an Oᵣ value of 98.6% and a D of 3.6 μm, meeting the relationship (1).

0.26×D+97≤Oᵣ≤0.26×D+99 (1)

TABLE 1

| | | Holding | Holding | Holding | |
|---|---|---|---|---|---|
| | | temperature | time | pressure | |
| | | (° C.) | (hr) | (kPa) | Cracks |
| Example | 1 | 400 | 1 | 80.1 | nil |
| | 2 | 400 | 1 | 53.3 | nil |
| | 3 | 400 | 1 | 26.7 | nil |
| | 4 | 400 | 1 | 13.4 | nil |
| | 5 | 600 | 1 | 80.1 | nil |
| | 6 | 600 | 1 | 53.3 | nil |
| | 7 | 600 | 1 | 26.7 | nil |
| | 8 | 600 | 1 | 13.4 | nil |
| | 9 | 800 | 1 | 80.1 | nil |
| | 10 | 800 | 1 | 53.3 | nil |
| | 11 | 800 | 1 | 26.7 | nil |
| | 12 | 800 | 1 | 13.4 | nil |
| | 13 | 1,000 | 1 | 80.1 | nil |
| | 14 | 1,000 | 1 | 53.3 | nil |
| | 15 | 1,000 | 1 | 26.7 | nil |
| | 16 | 1,000 | 1 | 13.4 | nil |
| Comparative | 1 | 100 | 1 | 106.7 | cracks |
| Example | 2 | 100 | 1 | 80.1 | cracks |
| | 3 | 100 | 1 | 53.3 | cracks |
| | 4 | 100 | 1 | 26.7 | cracks |
| | 5 | 100 | 1 | 13.4 | cracks |
| | 6 | 200 | 1 | 106.7 | cracks |
| | 7 | 200 | 1 | 80.1 | cracks |
| | 8 | 200 | 1 | 53.3 | cracks |
| | 9 | 200 | 1 | 26.7 | cracks |
| | 10 | 200 | 1 | 13.4 | cracks |
| | 11 | 400 | 1 | 106.7 | nil |
| | 12 | 600 | 1 | 106.7 | nil |
| | 13 | 800 | 1 | 106.7 | nil |
| | 14 | 1,000 | 1 | 106.7 | nil |
| | 15 | 100 | 1 | 7.5 | cracks |
| | 16 | 200 | 1 | 7.5 | cracks |
| | 17 | 400 | 1 | 7.5 | cracks |
| | 18 | 600 | 1 | 7.5 | cracks |
| | 19 | 800 | 1 | 7.5 | cracks |
| | 20 | 1,000 | 1 | 7.5 | cracks |

After the Nd magnet block was ground 0.1 mm on the surface, samples in the form of a rectangular piece of 6 mm by 6 mm by 3 mm were cut out of the edge and center portions of the Nd magnet block. The samples were analyzed for oxygen, carbon and nitrogen by infrared absorption gas analysis. The analytic results of carbon concentration are shown in Tables 2 to 4. The analytic results of oxygen and nitrogen concentrations were substantially equal within analytical errors among Examples 1 to 16 and Comparative Examples 1 to 20. Specifically, the oxygen concentration was 0.08 wt % and the nitrogen concentration was 0.02 wt %. In Comparative Examples 1 to 10, analysis was made outside the cracked area of the Nd magnet block. In Comparative Examples 15 to 20, no analysis was possible in the edge and center portions of the Nd magnet block because large cracks formed.

A comparison of Examples 1 to 16 with Comparative Examples 1 to 14 reveals that in Examples 1 to 16 meeting the requirements of the invention, the carbon concentration in the magnet center portion was as low as below 0.06 wt %, and the carbon concentration difference (ΔC) between magnet center and edge portions is reduced as low as below 0.03 wt %. On the other hand, where the holding temperature is lower than the range of the invention (stearic acid Td 376° C.), the lubricant is not fully decomposed, and hence, the overall magnet block including the center portion is not sufficiently reduced in carbon concentration. Where the holding pressure is higher than the range of the invention, ΔC becomes as high as 0.04 wt % or above. The reason is that the decomposition of the lubricant further proceeds in the magnet center portion, the amount of hydrocarbon gas given off increases accordingly, and the influence of gas attack becomes stronger in the magnet surface portion. On the other hand, where the holding pressure is lower than the range of the invention, cracks form in the magnet blocks as seen from Comparative Examples 15 to 20 in Table 1. Where the holding temperature is 400 to 800° C., there is observed the tendency that ΔC is rather small and the carbon concentration in the magnet center portion becomes lower.

### Examples 17 to 32 and Comparative Examples 21 to 40

Nd magnet blocks were prepared by the same procedure as in Example 1. The amount of the lubricant (stearic acid) added was changed to 0.1 part by weight per 100 parts by weight of the coarse pulverized powder. The heat treatment conditions are tabulated in Table 5. As in Example 1, the magnet blocks were analyzed for oxygen, carbon and nitrogen concentrations in edge and center portions. The analytic results of carbon concentration are shown in Tables 6 to 8. The analytic results of oxygen and nitrogen concentrations are substantially equal within analytical errors among Examples 17 to 32 and Comparative Examples 21 to 40. Specifically, the oxygen concentration was 0.09 wt % and the nitrogen concentration was 0.02 wt %. In Comparative Examples 21 to 30, analysis was made outside the cracked area of the Nd magnet block. In Comparative Examples 35 to 40, no analysis was possible in the edge and center portions of the Nd magnet block because large cracks formed. The Nd magnet block at its center portion was subjected to metal component analysis by ICP-OES. All the magnets of Examples 17 to 32 and Comparative Examples 21 to 40 consisted of Nd 24.1 wt %, Pr 6.5 wt %, Fe 66.3 wt %, Co 0.5 wt %, Cu 0.2 wt %, Zr 0.2 wt %, Al 0.1 wt %, B 1 wt %, Si 0.1 wt %, Ga 0.8 wt %, and the balance of impurity elements. The block was further measured for a degree of orientation Oᵣ (%) by EBSD and for an average crystal grain size D (μm) under a laser microscope. All the magnets of Examples 17 to 32 and Comparative Examples 21 to 40 had an Oᵣ value of 98.1% and a D of 3.6 μm, meeting the relationship (1).

TABLE 5

| | | Holding | Holding | Holding | |
|---|---|---|---|---|---|
| | | temperature | time | pressure | |
| | | (° C.) | (hr) | (kPa) | Cracks |
| Example | 17 | 400 | 1 | 80.1 | nil |
| | 18 | 400 | 1 | 53.3 | nil |
| | 19 | 400 | 1 | 26.7 | nil |
| | 20 | 400 | 1 | 13.4 | nil |
| | 21 | 600 | 1 | 80.1 | nil |
| | 22 | 600 | 1 | 53.3 | nil |
| | 23 | 600 | 1 | 26.7 | nil |
| | 24 | 600 | 1 | 13.4 | nil |
| | 25 | 800 | 1 | 80.1 | nil |
| | 26 | 800 | 1 | 53.3 | nil |
| | 27 | 800 | 1 | 26.7 | nil |
| | 28 | 800 | 1 | 13.4 | nil |
| | 29 | 1,000 | 1 | 80.1 | nil |
| | 30 | 1,000 | 1 | 53.3 | nil |
| | 31 | 1,000 | 1 | 26.7 | nil |
| | 32 | 1,000 | 1 | 13.4 | nil |
| Comparative | 21 | 100 | 1 | 106.7 | cracks |
| Example | 22 | 100 | 1 | 80.1 | cracks |
| | 23 | 100 | 1 | 53.3 | cracks |
| | 24 | 100 | 1 | 26.7 | cracks |
| | 25 | 100 | 1 | 13.4 | cracks |
| | 26 | 200 | 1 | 106.7 | cracks |
| | 27 | 200 | 1 | 80.1 | cracks |
| | 28 | 200 | 1 | 53.3 | cracks |
| | 29 | 200 | 1 | 26.7 | cracks |
| | 30 | 200 | 1 | 13.4 | cracks |
| | 31 | 400 | 1 | 106.7 | nil |
| | 32 | 600 | 1 | 106.7 | nil |
| | 33 | 800 | 1 | 106.7 | nil |
| | 34 | 1,000 | 1 | 106.7 | nil |
| | 35 | 100 | 1 | 7.5 | cracks |
| | 36 | 200 | 1 | 7.5 | cracks |
| | 37 | 400 | 1 | 7.5 | cracks |
| | 38 | 600 | 1 | 7.5 | cracks |
| | 39 | 800 | 1 | 7.5 | cracks |
| | 40 | 1,000 | 1 | 7.5 | cracks |

A comparison of Examples 17 to 32 with Comparative Examples 21 to 34 reveals that in Examples 17 to 32 meeting the requirements of the invention, the carbon concentration in the magnet center portion was as low as below 0.04 wt %, and the carbon concentration difference (ΔC) between magnet center and edge portions is reduced as low as below 0.02 wt %. On the other hand, where the holding temperature is lower than the range of the invention (stearic acid Td 376° C.), the lubricant is not fully decomposed, and hence, the overall magnet block including the center portion is not sufficiently reduced in carbon concentration. Where the holding pressure is higher than the range of the invention, ΔC becomes as high as 0.03 wt % or above. The reason is that the decomposition of the lubricant further proceeds in the magnet center portion, the amount of hydrocarbon gas given off increases accordingly, and the influence of gas attack becomes stronger in the magnet surface portion. On the other hand, where the holding pressure is lower than the range of the invention, cracks form in the magnet blocks as seen from Comparative Examples 35 to 40 in Table 5. Where the holding temperature is 600 to 800° C., there is observed the tendency that ΔC is rather small and the carbon concentration in the magnet center portion becomes lower.

### Examples 33 to 38

Nd magnet blocks were prepared by the same procedure as in Example 17. The holding time during the atmosphere heat treatment was changed. The heat treatment conditions are tabulated in Table 9. As in Example 1, the magnet blocks were analyzed for oxygen, carbon and nitrogen concentrations in edge and center portions. The analytic results of carbon concentration are shown in Table 10. The analytic results of oxygen and nitrogen concentrations are substantially equal within analytical errors among Examples 33 to 38. Specifically, the oxygen concentration was 0.09 wt % and the nitrogen concentration was 0.02 wt %. The Nd magnet block at its center portion was subjected to metal component analysis by ICP-OES. All the magnets of Examples 33 to 38 consisted of Nd 24.1 wt %, Pr 6.5 wt %, Fe 66.3 wt %, Co 0.5 wt %, Cu 0.2 wt %, Zr 0.2 wt %, Al 0.1 wt %, B 1 wt %, Si 0.1 wt %, Ga 0.8 wt %, and the balance of impurity elements. The block was further measured for a degree of orientation Oᵣ (%) by EBSD and for an average crystal grain size D (μm) under a laser microscope. All the magnets had an Oᵣ value of 98.1% and a D of 3.6 μm, meeting the relationship (1).

TABLE 9

| | | Holding | Holding | Holding | |
|---|---|---|---|---|---|
| | | temperature | time | pressure | |
| | | (° C.) | (hr) | (kPa) | Cracks |
| Example | 33 | 600 | 0.2 | 80.1 | nil |
| | 34 | 600 | 0.5 | 80.1 | nil |
| | 35 | 600 | 1 | 80.1 | nil |
| | 36 | 600 | 5 | 80.1 | nil |
| | 37 | 600 | 10 | 80.1 | nil |
| | 38 | 600 | 20 | 80.1 | nil |

TABLE 10

| | Example | | | | | |
|---|---|---|---|---|---|---|
| | 33 | 34 | 35 | 36 | 37 | 38 |
| Holding time (hr) | 0.2 | 0.5 | 1 | 5 | 10 | 20 |
| Carbon concentration | 0.040 | 0.038 | 0.036 | 0.034 | 0.034 | 0.035 |
| in center portion | | | | | | |
| Carbon concentration | 0.056 | 0.053 | 0.053 | 0.051 | 0.052 | 0.055 |
| in edge portion | | | | | | |
| Concentration | 0.016 | 0.015 | 0.017 | 0.017 | 0.018 | 0.020 |
| difference ΔC | | | | | | |

(wt %)

Examples 33 to 38 demonstrate that when the holding time is in the range of 0.5 to 10 hours, the carbon concentrations in the magnet center and edge portions are reduced to a lower level than under other conditions, and ΔC remains approximately equal. It is thus believed that as long as the holding time is in the range, the decomposition of the lubricant proceeds to a full extent and the heat treatment is terminated before the influence of gas attack becomes significant.

### Examples 39 to 51

Nd magnet blocks were prepared by the same procedure as in Example 17. In the atmosphere heat treatment of the sintering step, vacuum evacuation and inert gas supply were alternately repeated under the conditions of Table 11 (this treatment is referred to as atmosphere gas exchange treatment, hereinafter). As in Example 1, the magnet blocks were analyzed for oxygen, carbon and nitrogen concentrations in edge and center portions. The analytic results of carbon concentration are shown in Table 12. The analytic results of oxygen and nitrogen concentrations are substantially equal within analytical errors among Examples 39 to 51. Specifically, the oxygen concentration was 0.09 wt % and the nitrogen concentration was 0.02 wt %. The Nd magnet block at its center portion was subjected to metal component analysis by ICP-OES. All the magnets of Examples 39 to 51 consisted of Nd 24.1 wt %, Pr 6.5 wt %, Fe 66.3 wt %, Co 0.5 wt %, Cu 0.2 wt %, Zr 0.2 wt %, Al 0.1 wt %, B 1 wt %, Si 0.1 wt %, Ga 0.8 wt %, and the balance of impurity elements. The block was further measured for a degree of orientation by EBSD and for an average crystal grain size under a laser microscope. All the magnets had an Oᵣ value of 98.1% and a D of 3.6 μm, meeting the relationship (1).

TABLE 11

| | | Vacuum | Inert gas | | Upper | Lower |
|---|---|---|---|---|---|---|
| | | evacuation | supply | Holding | limit | limit |
| | | rate | rate | pressure | pressure | pressure |
| | | (kPa/min) | (kPa/min) | (kPa) | (kPa) | (kPa) |
| Example | 39 | 0.05 | 10 | 80.1 | 90.1 | 70.1 |
| | 40 | 0.1 | 10 | 80.1 | 90.1 | 70.1 |
| | 41 | 1 | 10 | 80.1 | 90.1 | 70.1 |
| | 42 | 10 | 10 | 80.1 | 90.1 | 70.1 |
| | 43 | 100 | 10 | 80.1 | 90.1 | 70.1 |
| | 44 | 1,000 | 10 | 80.1 | 90.1 | 70.1 |
| | 45 | 1,500 | 10 | 80.1 | 90.1 | 70.1 |
| | 46 | 10 | 0.5 | 80.1 | 90.1 | 70.1 |
| | 47 | 10 | 1 | 80.1 | 90.1 | 70.1 |
| | 48 | 10 | 10 | 80.1 | 90.1 | 70.1 |
| | 49 | 10 | 50 | 80.1 | 90.1 | 70.1 |
| | 50 | 10 | 100 | 80.1 | 90.1 | 70.1 |
| | 51 | 10 | 150 | 80.1 | 90.1 | 70.1 |

TABLE 12

| | | Carbon | Carbon | |
|---|---|---|---|---|
| | | concentration | concentration | Concentration |
| | | in center | in edge | difference |
| | | portion | portion | ΔC |
| Example | 39 | 0.036 | 0.053 | 0.017 |
| | 40 | 0.035 | 0.048 | 0.013 |
| | 41 | 0.035 | 0.045 | 0.010 |
| | 42 | 0.036 | 0.045 | 0.009 |
| | 43 | 0.036 | 0.046 | 0.010 |
| | 44 | 0.039 | 0.050 | 0.011 |
| | 45 | 0.045 | 0.055 | 0.010 |
| | 46 | 0.036 | 0.054 | 0.018 |
| | 47 | 0.035 | 0.048 | 0.013 |
| | 48 | 0.036 | 0.045 | 0.009 |
| | 49 | 0.036 | 0.047 | 0.011 |
| | 50 | 0.039 | 0.049 | 0.010 |
| | 51 | 0.045 | 0.055 | 0.010 |

(wt %)

Examples 39 to 51 in comparison with Example 21 demonstrate the following. Where the vacuum evacuation rate is 0.1 to 1,000 kPa/min and the inert gas supply rate is 1 to 100 kPa/min (Examples 40 to 44 and 47 to 50), the carbon concentration in the magnet surface portion is further reduced and ΔC is accordingly reduced. This is because in the atmosphere heat treatment, the hydrocarbon gas introduced in the inert gas atmosphere from decomposition of the lubricant is removed via the repetition of vacuum evacuation and inert gas supply, so that the gas attack at the magnet surface is restrained. On the other hand, when the evacuation rate in the vacuum evacuation is very slow (Example 39) or the inert gas supply rate is very slow (Example 46), the hydrocarbon gas introduced in the inert gas atmosphere is not completely removed, with the results being substantially equal to Example 21 wherein the atmosphere gas exchange treatment is excluded. When the evacuation rate in the vacuum evacuation is very high (Example 45) or the inert gas supply rate is very high (Example 51), not only the hydrocarbon gas in the system is removed, but also the hydrogen gas for promoting decomposition of the lubricant in the magnet is excessively removed, so that the carbon concentrations in the magnet center and edge portions are slightly increased despite a reduction of ΔC.

### Examples 52 to 56

Nd magnet blocks were prepared by the same procedure as in Example 17. In the atmosphere heat treatment of the sintering step, atmosphere gas exchange treatment was performed under the conditions of Table 13. As in Example 1, the magnet blocks were analyzed for oxygen, carbon and nitrogen concentrations in edge and center portions. The analytic results of carbon concentration are shown in Table 14. The analytic results of oxygen and nitrogen concentrations are substantially equal within analytical errors among Examples 52 to 56. Specifically, the oxygen concentration was 0.09 wt % and the nitrogen concentration was 0.02 wt %. The Nd magnet block at its center portion was subjected to metal component analysis by ICP-OES. All the magnets of Examples 52 to 56 consisted of Nd 24.1 wt %, Pr 6.5 wt %, Fe 66.3 wt %, Co 0.5 wt %, Cu 0.2 wt %, Zr 0.2 wt %, Al 0.1 wt %, B 1 wt %, Si 0.1 wt %, Ga 0.8 wt %, and the balance of impurity elements. The block was further measured for a degree of orientation by EBSD and for an average crystal grain size under a laser microscope. All the magnets had an Oᵣ value of 98.1% and a D of 3.6 μm, meeting the relationship (1).

TABLE 13

| | | Vacuum | Inert gas | | Upper | Lower |
|---|---|---|---|---|---|---|
| | | evacuation | supply | Holding | limit | limit |
| | | rate | rate | pressure | pressure | pressure |
| | | (kPa/min) | (kPa/min) | (kPa) | (kPa) | (kPa) |
| Example | 52 | 10 | 10 | 60 | 70 | 40 |
| | 53 | 10 | 10 | 60 | 80 | 40 |
| | 54 | 10 | 10 | 60 | 90 | 40 |
| | 55 | 10 | 10 | 60 | 80 | 50 |
| | 56 | 10 | 10 | 60 | 80 | 30 |

TABLE 14

| | | Carbon | Carbon | |
|---|---|---|---|---|
| | | concentration | concentration | Concentration |
| | | in center | in edge | difference |
| | | portion | portion | ΔC |
| Example | 52 | 0.036 | 0.046 | 0.010 |
| | 53 | 0.033 | 0.049 | 0.016 |
| | 54 | 0.040 | 0.052 | 0.012 |
| | 55 | 0.035 | 0.048 | 0.013 |
| | 56 | 0.041 | 0.051 | 0.010 |

(wt %)

Examples 52 to 56 demonstrate the following. In Examples 52, 53 and 55 wherein the inert gas atmosphere pressure is controlled in the range from more than 0.5 Pₖ to less than 1.5 Pₖ relative to the predetermined holding pressure Pₖ (=60 kPa in Examples 52 to 56), the carbon concentrations in the magnet center and edge portions and ΔC are reduced, as compared with the case where the inert gas atmosphere pressure is outside the range. In Examples 54 and 56 wherein the inert gas atmosphere pressure is outside the range, like Examples 45 and 51, not only the hydrocarbon gas in the system is removed, but also the hydrogen gas for promoting decomposition of the lubricant in the magnet is excessively removed, so that the carbon concentrations in the magnet center and edge portions are slightly increased despite a reduction of ΔC.

It has been demonstrated that the rare earth sintered magnets prepared in Examples 1 to 56 by the inventive method have a fully low carbon concentration as well as oxygen and nitrogen concentrations and a small difference in carbon concentration between magnet surface and center portions. The magnets are fully useful in the application requiring a high coercivity, typically electric vehicles.

Japanese Patent Application No. 2020-087344 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for preparing a rare earth sintered magnet,
said sintered magnet consisting essentially of R, T, B, M¹, and M² wherein R is at least one element selected from rare earth elements, essentially including neodymium, T is at least one element selected from iron group elements, essentially including iron, B is boron, M¹ is at least one element selected from the group consisting of Al, Si, Cr, Mn, Cu, Zn, Ga, Ge, Mo, Sn, W, Pb, and Bi, and M² is at least one element selected from the group consisting of Ti, V, Zr, Nb, Hf, and Ta,
the method comprising the steps of melting raw materials to form a starting alloy having a predetermined composition, pulverizing the starting alloy into an alloy fine powder, compression shaping the alloy fine powder under a magnetic field into a compact, and sintering the compact by heat treatment at a sintering temperature into a sintered magnet, wherein
the pulverizing step includes coarse pulverizing and fine pulverizing steps, the coarse pulverizing step including a hydrogen decrepitation step, the pulverizing step further includes the step of adding a lubricant before or after the coarse pulverizing step,
the sintering step includes an atmosphere heat treatment and a vacuum heat treatment,
said atmosphere heat treatment including the steps of heating the compact at a predetermined temperature ranging from the decomposition temperature of the lubricant to the sintering temperature, and holding at the predetermined temperature for a predetermined time, the heating and holding steps being carried out in an inert gas atmosphere under a pressure of 10 to 100 kPa, and
said vacuum heat treatment including the steps of switching the atmosphere to a vacuum atmosphere after the atmosphere heat treatment and heating the compact in the vacuum atmosphere at the sintering temperature.

2. The method of claim 1 wherein the lubricant is at least one compound selected from the group consisting of stearic acid, zinc stearate, decanoic acid, and lauric acid.

3. The method of claim 1 wherein the inert gas of the inert gas atmosphere used in said atmosphere heat treatment is He gas, Ar gas or N₂ gas.

4. The method of claim 1 wherein the predetermined temperature ranging from the decomposition temperature of the lubricant to the sintering temperature is in the range of 400° C. to 800° C.

5. The method of claim 1 wherein the holding time at the predetermined temperature during said atmosphere heat treatment is 0.5 to 10 hours.

6. The method of claim 1 wherein the hydrogen decrepitation step is under a hydrogen pressure of at least 100 kPa,
the fine pulverizing step includes finely pulverizing the coarsely pulverized starting alloy in a non-oxidizing gas atmosphere having a water content of up to 100 ppm to a volume basis median diameter D₅₀ of 0.2 to 10 μm.

7. The method of claim 1 wherein during said atmosphere heat treatment, the steps of vacuum evacuating at a rate of 0.1 to 1,000 kPa/min and subsequently introducing the inert gas at a rate of 0.1 to 100 kPa/min are performed plural times while keeping the inert gas atmosphere pressure of 10 to 100 kPa.

8. The method of claim 7 wherein during said atmosphere heat treatment, the inert gas atmosphere pressure which is in the range of 10 to 100 kPa is changed from more than 0.5 Pₖ to less than 1.5 Pₖ, provided that a predetermined pressure Pₖ is set within the range.

9. A rare earth sintered magnet which is prepared by a technique of using a hydrogen-containing powder during fine pulverization of a starting alloy, wherein the difference ΔC between a carbon concentration Cₛ in a magnet surface portion and a carbon concentration C_{c} in a magnet center portion is 0.005 to 0.03% by weight.

10. The rare earth sintered magnet of claim 9, which consists essentially of R, T, B, M¹, and M² wherein R is at least one element selected from rare earth elements, essentially including neodymium, T is at least one element selected from iron group elements, essentially including iron, B is boron, M¹ is at least one element selected from the group consisting of Al, Si, Cr, Mn, Cu, Zn, Ga, Ge, Mo, Sn, W, Pb, and Bi, and M² is at least one element selected from the group consisting of Ti, V, Zr, Nb, Hf, and Ta, the magnet having an oxygen content of up to 0.1% by weight, a nitrogen content of up to 0.05% by weight, and a carbon content of up to 0.07% by weight.

11. The rare earth sintered magnet of claim 9, having a R content of 12.0 to 16.0 atom %, a M¹ content of 0.1 to 2.0 atom %, and a M² content of 0.1 to 0.5 atom % wherein R is at least one element selected from rare earth elements, essentially including neodymium, M¹ is at least one element selected from the group consisting of Al, Si, Cr, Mn, Cu, Zn, Ga, Ge, Mo, Sn, W, Pb, and Bi, and M² is at least one element selected from the group consisting of Ti, V, Zr, Nb, Hf, and Ta.

12. The rare earth sintered magnet of claim 9, having an average crystal grain size of up to 4 μm.

13. The rare earth sintered magnet of claim 9, having a degree of orientation Oᵣ (%) and an average crystal grain size D (μm), which meet the relationship (1):
26×D+97≤Oᵣ≤0.26×D+99 (1).

14. The rare earth sintered magnet of claim 9, wherein with respect to major phase grains at least in an area delineated within 500 μm from the surface of the sintered magnet, each major phase grain contains in at least a portion near the major phase grain surface, a region having a higher concentration of R′ than at the major phase grain center, wherein R′ is at least one element selected from rare earth elements and constitutes at least a part of R.
